(19) United States
(12) Patent Application Publication
(10) Pub. No.: US 2010/0015864 A1
(43) Pub. Date: Jan. 21, 2010

(54) MANUFACTURING METHOD OF PIN-LIKE MALE TERMINAL FOR BOARD-MOUNTING CONNECTOR

(75) Inventor: Kazuki ZAITSU, Makinohara-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/499,861

(22) Filed: Jul. 9, 2009

(30) Foreign Application Priority Data
Jul. 15, 2008 (JP) 2008-183896

(51) Int. Cl. H01R 13/02; H01R 43/16

(52) U.S. Cl. 439/885; 29/874

(57) ABSTRACT

A method of manufacturing a terminal for a board-mounting connector, wherein the terminal includes two L-shaped bent portions formed at its intermediate portion between its front and rear ends, a straight electrical contact portion formed at its front end, and a straight rear leg portion, the method includes a stamping operation applied to a stock to form a stamped-out terminal including the two bent portions, the electrical contact portion and the rear leg portion.

### CROSS-REFERENCE TO RELATED APPLICATIONS

This application claims priority from Japanese Patent Application No. 2008-183896 filed on Jul. 15, 2008, the entire subject matter of which is incorporated herein by reference.

### TECHNICAL FIELD

This invention relates to a method of producing a pin-like male terminal for a board-mounting connector.

### BRIEF DESCRIPTION OF THE RELATED ART

FIG. 7 is a cross-sectional view of an related surface-mounting (board-mounting) connector disclosed, for example, in JP-A-2005-235498.

This related connector 100 includes a resin-made connector housing 110, and pin-like male terminals 120 and 130 mounted on a rear wall 111 of the connector housing 110 by press-fitting or insert-molding. Electrical contact portions 121 and 131 of the male terminals 120 and 130 formed respectively at front ends of the male terminals 120 and 130 project into the interior of a fitting hood portion 112 of the connector housing 1 10. When a mating male connector is fitted into the fitting hood portion 112, the electrical contact portions 121 and 131 of the male terminals 120 and 130 are electrically connected respectively to terminals of the mating connector.

Each of the male terminals 120 and 130 includes two L-shaped bent portions 123 and 124, 133 and 134 formed at its intermediate portion between its opposite (front and rear) ends, the straight electrical contact portion 121, 131 formed at its front end so as to be connected to the terminal of the mating connector, and a straight rear leg portion 122, 132 for being soldered to a board K on which the board-mounting connector is to be mounted.

Each of the pin-like male terminals 120 and 130 for the board-mounting connector of this type has been formed by bending a straight wire. Generally, the male terminal was mounted on the connector housing by press-fitting or insert-molding, and thereafter the portion of the male terminal projecting rearwardly from the connector housing was bent.

With such bending operation, however, a required precision of the rear leg portion 122, 132 was sometimes not obtained because of the effect of spring back.

### SUMMARY

With the above circumstances in view, it is an object of this invention to provide a manufacturing method of a pin-like male terminal for a board-mounting connector, in which a rear leg portion of the male terminal is precisely formed without being affected by spring back.

A first aspect of the invention is a method of manufacturing a terminal for a board-mounting connector, wherein the terminal includes two L-shaped bent portions formed at its intermediate portion between its front and rear ends, a straight electrical contact portion formed at its front end, and a straight rear leg portion, including a stamping operation applied to a stock to form a stamped-out terminal including the two bent portions, the electrical contact portion and the rear leg portion.

A second aspect of the invention according to the first aspect of the invention is that the stamping operation forms a projection formed at a proximal end portion of the electrical contact portion.

A third aspect of the invention according to the first aspect of the invention is that a plurality of the terminals each having a generally Z-shape are stamped in a chained condition out of the stock such that interconnecting portions interconnect proximal end portions of the electrical contact portions of the terminals; subsequently plating is applied to the flat plate stock having said stamped-out terminals; and subsequently the interconnecting portions are cut out to separate the terminals as single products from one another.

A fourth aspect of the invention according to the third aspect of the invention is that the interconnecting portions are broken such that part of each of said interconnecting portions remains at the proximal end portion of said electrical contact portion to form a projection.

A fifth aspect of the invention according to the third or the fourth aspect of the invention is that the plurality of terminals are stamped out such that the terminals are arranged parallel to one another, with the electrical contact portions and the rear leg portions inclined relative to a transverse direction and a longitudinal direction of said flat plate stock.

A sixth aspect of the invention is A flat plate stock used for manufacturing a terminal includes a first edge running in a first direction; a second edge running in a second direction; a plurality of interconnecting portion each of which inter connects between two adjacent stumped terminals; and a plurality of stumped terminals. Each of the stumped terminals are parallelly arranged along the second edge and includes a first portion inclined to the first edge; a second portion inclined to the first portion and the first edge; and a third portion inclined to the second portion.

According to the first aspect, the bent shape of the male terminal is formed not by a bending operation but by the stamping operation, and therefore the male terminal is free from the effect of spring back, and the rear leg portion is formed into a satisfactory precision.

According to the second aspect, the projection is formed at the proximal end portion of the electrical contact portion, and therefore in either of the case where the male terminal is inserted in a mold, and then the connector housing is molded with the male terminal insert molded therein and the case where the male terminal is press-fitted into the molded connector housing, the male terminal is positively fixed to the connector housing.

According to the third aspect, the plurality of male terminals are stamped out in the chained condition, and therefore the plating of these male terminals is efficiently effected at a time. Although the interconnecting portions disposed at the proximal end portions of the electrical contact portions are broken after the plating operation, the effect of the plating will not be adversely affected at all since the interconnecting portions are remote from the electrical contact portions (that is, the front end portions) and the rear leg portions.

According to the fourth aspect, when the interconnecting portions are broken, the projections remain respectively at the proximal end portions of the electrical contact portions, and therefore the projections is easily formed.

According to the fifth aspect, the terminals are stamped out of the flat plate stock such that these male terminals are arranged parallel to one another in the inclined condition, and therefore an enhanced yield is achieved.

### BRIEF DESCRIPTION OF THE DRAWINGS

FIG. 1 is a perspective explanatory view of a male terminal-manufacturing method of the present invention, showing a plurality of male terminals are stamped out in a chained condition.

FIG. 2 is an enlarged perspective view showing interconnecting portions of the male terminals are cut out.

FIG. 3 is a perspective view of the male terminal as a single product.

FIG. 4 is transverse cross-sectional view of a board-mounting connector which has the male terminals mounted on its connector housing and is surface mounted on a board.

FIG. 5 is a rear view of the board-mounting connector.

FIG. 6 is a perspective view of the board-mounting connector as seen from the front side.

FIG. 7 is a transverse cross-sectional view of a related board-mounting connector.

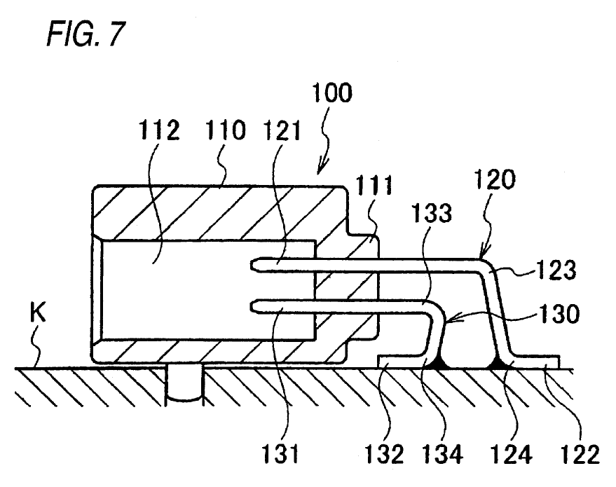

### DETAIL DESCRIPTION OF EXEMPLARY EMBODIMENTS OF THE PRESENT INVENTION

A preferred embodiment of the present invention will now be described with reference to the drawings.

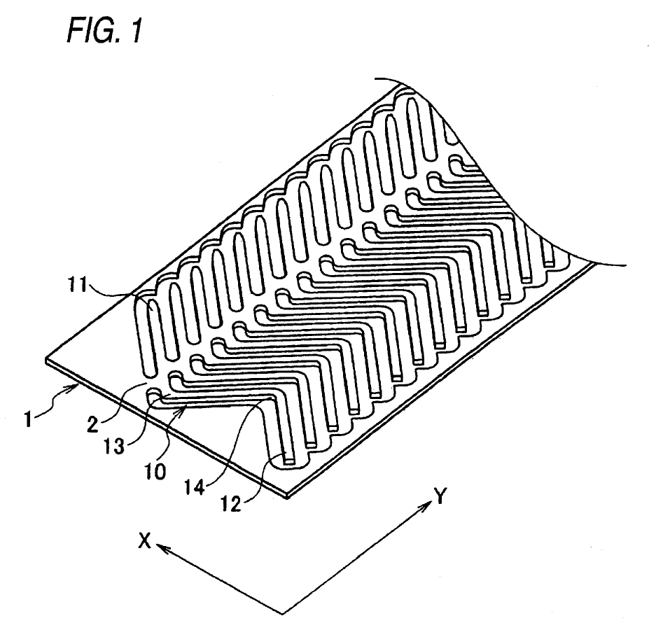

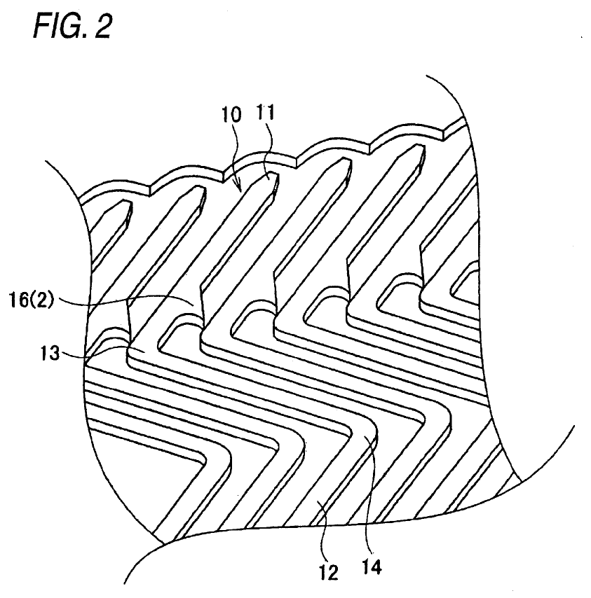

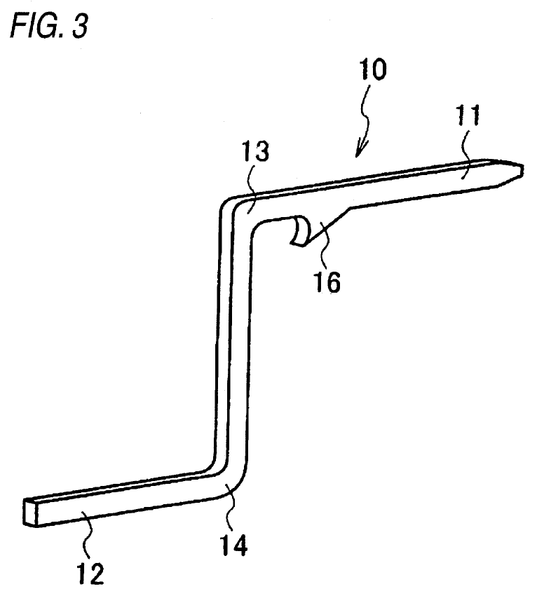

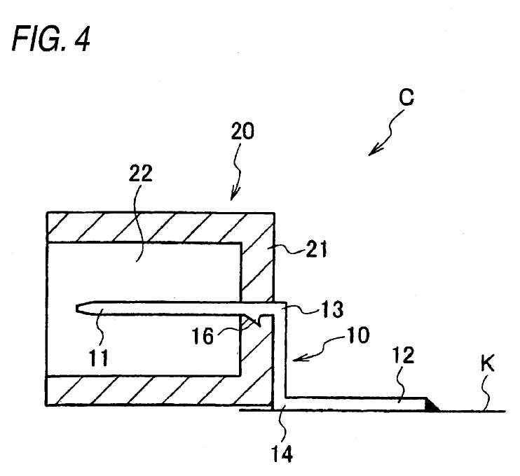

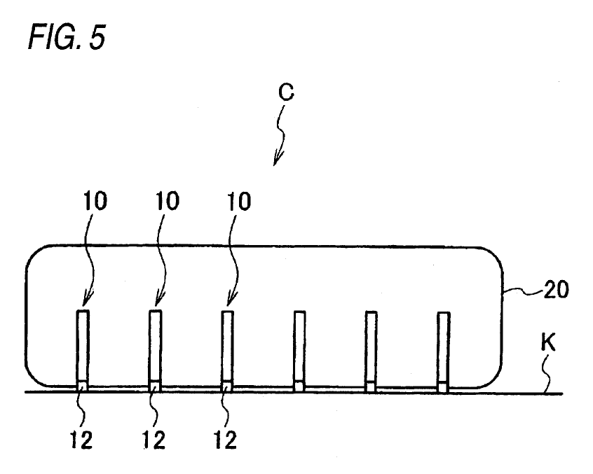

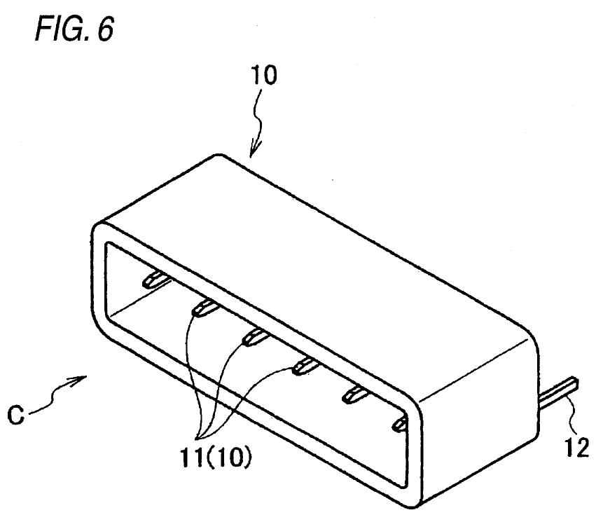

FIG. 1 is a perspective view showing a condition in which a plurality of male terminals are stamped out in a chained condition, FIG. 2 is an enlarged perspective view showing interconnecting portions of the male terminals interconnected in the chained condition are cut out, FIG. 3 is a perspective view of the male terminal as a single product obtained as result of the cut out operation, FIG. 4 is transverse cross-sectional view of a board-mounting connector which has the male terminals mounted on its connector housing and is surface mounted on a board, FIG. 5 is a rear view of the board-mounting connector, and FIG. 6 is a perspective view of the board-mounting connector as seen from the front side.

As shown in FIG. 3, the pin-like male terminal 10 which is to be produced by a method of the invention has a generally Z-shape, and includes two L-shaped bent portions 13 and 14 formed at its intermediate portion between its opposite (front and rear) ends, a straight electrical contact portion 11 formed at its front end so as to be connected to a terminal of a mating connector, and a straight rear leg portion 12 for being soldered to the board K (see FIG. 4) on which the board-mounting connector is to be mounted.

In the male terminal-manufacturing method of this exemplary embodiment, a stamping, blanking operation or the like is applied to one strip-like flat plate stock 1 to thereby form or shape the male terminals 10 each having the two bent portions 13 and 14, the electrical contact portion 11 and the rear leg portion 12, as shown in FIG. 1. At this time, a plurality of male terminals 10 are stamped out into a chained condition such that the interconnecting portions 12 interconnect proximal end portions of the electrical contact portions 11 of the male terminals 10. Also, this stamping operation is carried out such that the male terminals 10 are arranged parallel to one another in a row, with the electrical contact portions 11 and the rear leg portions 12 inclined relative to a transverse direction (direction of arrow X) and a longitudinal direction (direction of arrow Y) of the flat plate stock 1.

Then, plating is applied to the flat plate stock 1 having the stamped-out male terminals 10, and thereafter the interconnecting portions 2 are cut out, thereby separating the male terminals 10 as single products from one another. At this time, the interconnecting portions 2 are broken such that part of each interconnecting portion 2 remains at the proximal end portion of the electrical contact portion 11 to form a projection 16 which serves to retain the male terminal 10 from withdrawal from the connector housing 20 when the male terminal 10 is mounted on the connector housing 20.

The thus produced male terminals 10 are retained on a rear wall 21 of the connector housing 20 by press-fitting or insert-molding as shown in FIGS. 4 to 6. Thus, the board-mounting connector C is completed. In this condition, the electrical contact portion 11 of each male terminal 10 projects straight forwardly into the interior of a fitting hood portion 22 of the connector housing 20, and the projection 16 is disposed in the rear wall 21, and the rear leg portion 12 extends rearwardly from the connector housing 20.

For mounting the board-mounting connector C on the board K, the board-mounting connector C is placed on the board K having a solder paste coated thereon. Then the board-mounting connector C, together with the board K, is passed through a reflow furnace, thereby soldering the rear leg portions 12 of the male terminals 10 to the board K.

As described above, in the male terminal-producing method of this exemplary embodiment, the bent shape of the male terminal 10 is formed not by a bending operation but by the stamping (or blanking) operation, and therefore the male terminal is free from the effect of spring back, and the rear leg portion 12 is formed into a satisfactory precision.

Furthermore, the plurality of male terminals 10 are stamped out in the chained condition, and therefore the plating of these male terminals 10 is efficiently effected at a time. Although the interconnecting portions 2 disposed at the proximal end portions of the electrical contact portions 11 are cut out after the plating operation, the effect of the plating is not be adversely affected at all since the interconnecting portions 12 are remote from the electrical contact portions 11 (that is, the front end portions) and the rear leg portions 12.

Furthermore, the male terminals 10 are stamped out of the flat plate stock 1 such that these male terminals 10 are arranged parallel to one another in the inclined condition, and therefore an enhanced yield can be achieved.

Furthermore, the projection 16 is formed at the proximal end portion of the electrical contact portion 11, and therefore in either of the case where the male terminals 10 are inserted in a mold, and then the connector housing 20 is molded with the male terminals 10 insert molded therein and the case where the male terminals 10 are press-fitted into the molded connector housing 20, the male terminals 10 can be positively fixed to the connector housing 20.

Particularly when the interconnecting portions 2 are cut out, the projections 16 remain respectively at the proximal end portions of the electrical contact portions 11, and therefore the projections 16 can be easily formed.

1. A method of manufacturing a terminal for a board-mounting connector, wherein the terminal includes two L-shaped bent portions formed at its intermediate portion between its front and rear ends, a straight electrical contact portion formed at its front end, and a straight rear leg portion, comprising:
a stamping operation applied to a flat plate to form a plurality of terminal shapes each of which including the two bent portions, the electrical contact portion and the rear leg portion.

2. The terminal manufacturing method according to claim 1, wherein the stamping operation forms a projection formed at a proximal end portion of the electrical contact portion.

3. The terminal manufacturing method according to claim 1, wherein a plurality of the terminals each having a generally Z-shape are stamped in a chained condition out of the flat plate such that interconnecting portions interconnect proximal end portions of the electrical contact portions of the adjacent terminals; subsequently plating is applied to the flat plate having the terminal shape; and subsequently the interconnecting portions are cut out to separate the terminals.

4. The terminal manufacturing method according to claim 3, wherein the interconnecting portions are cut out such that part of each of the interconnecting portions remains at the proximal end portion of the electrical contact portion to form a projection.

5. The terminal producing method according to claim 3 wherein the plurality of terminal shapes are stamped such that the terminal shapes are arranged parallel to one another, with the electrical contact portions and the rear leg portions inclined relative to a transverse direction and a longitudinal direction of said flat plate flat plate.

6. The terminal manufacturing method according to claim 4, wherein the plurality of terminals are stamped such that the terminals are arranged parallel to one another, with the electrical contact portions and the rear leg portions inclined relative to a transverse direction and a longitudinal direction of said flat plate flat plate.

7. A method of manufacturing a board-mounting connector, wherein the board-mounting connector comprises:
a plurality of terminals includes two L-shaped bent portions formed at its intermediate portion between its front and rear ends, a straight electrical contact portion formed at its front end, and a straight rear leg portion;
a resin housing; and
a board, the method comprising:
a stamping operation applied to a flat plate to form a plurality of terminal shapes each of which includes the two bent portions, the electrical contact portion and the rear leg portion;
a cutting out operation applied to the flat plate to obtain the plurality of terminals;
a inserting operation to insert the electrical contact portion of each terminal into the resin housing; and
a soldering operation to solder the straight rear leg to the board.

8. A flat plate stock used for manufacturing a terminal comprising:
a first edge running in a first direction;
a second edge running in a second direction;
a plurality of stumped terminals each of which are parallelly arranged and comprises:
a first portion inclined to the first edge;
a second portion inclined to the first portion and the first edge; and
a third portion inclined to the second portion; and
a plurality of interconnecting portion each of which interconnects between two adjacent stumped terminals.
